(19) United States
(12) Patent Application Publication
(10) Pub. No.: US 2009/0095591 A1
(43) Pub. Date: Apr. 16, 2009

(54) SPRAG RETAINER FOR AN OVERRUNNING CLUTCH

(76) Inventor: Thaddeus F. Zlotek, Center Line, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/871,542

(22) Filed: Oct. 12, 2007

(51) Int. Cl. F16D 23/00

(52) U.S. Cl. 192/63; 192/114 R

(57) ABSTRACT

A retainer for sprags in an overrunning clutch is provided. The retainer is disposed between the inner and outer races of the clutch. The retainer includes first and second rings disposed about an axis and axially spaced from one another and a plurality of cross bars extending between the first and second rings. The plurality of cross bars are circumferentially spaced and define a plurality of openings. Each opening is configured to receive one of the sprags disposed between the inner and outer races of the clutch. At least the cross bars of the retainer are made from a tool steel, preferably S7 tool steel. The construction of the retainer increases the abrasion resistance of the retainer and extends the service life of the clutch.

### BACKGROUND OF THE INVENTION

1. Field of the Invention

This invention relates to overrunning clutches and, in particular, to a sprag retainer for an overrunning clutch having improved wear characteristics to increase the service life of both the clutch and systems in which the clutch is used.

2. Discussion of Related Art

Rotational coupling devices such as overrunning clutches are used to control transfer of torque between rotational bodies. An overrunning clutch is designed to transfer torque from a driving member to a driven member in one rotational direction. The overrunning clutch permits the driven member to freewheel or overrun the driving member when (i) the rotational speed of the driven member exceeds the rotational speed of the driving member or (ii) the driven member rotates in the opposite rotational direction from the driving member. One of the benefits of an overrunning clutch is that it allows for the overrunning of large inertia loads upon stopping and prevents any back-driving damage that may occur to the drive system. Overrunning clutches are commonly used in applications such as dual motor/engine drives, conveyors belts, creep and starter drives and the disengagement of centrifugal masses.

One conventional overrunning clutch includes radially spaced inner and outer race members that rotate about a common rotational axis. A plurality of sprags are disposed between the inner and outer race members. The sprags are biased by springs into a preset position in which the sprags engage the inner and outer race members to transmit torque. If the driven race member rotates in the opposite direction or rotates in the driving direction at a higher speed than the driving race member, the sprags disengage from the driven race member and allow the driven member to freewheel or overrun the driving race member. The sprags are positioned using a cage or retainer disposed between the inner and outer race members. The retainer includes a pair of axially spaced rings joined by a plurality of cross bars that define openings or slots in which the sprags are received. The retainer is typically made from a low carbon alloy steel.

Conventional overrunning clutches like the one described hereinabove have, in certain applications (e.g., aircraft drive systems, helicopters and auxiliary power units), had a relatively short service life. It has been determined that the engagement of the sprags with the cross bars in the retainer has caused excessive abrasion of the cross bars. This, in turn, can lead to damage and misalignment of the sprags and damage to the clutch as a whole as well as to the drive systems in which the clutch is employed. Because of the relatively short service life of the clutch, systems employing the clutch (e.g., aircraft systems) require more frequent inspection to ensure proper operation. The time required for inspection (including disassembly) of these systems reduces the operating time of the vehicle and leads to increased costs.

The inventors herein have recognized a need for a sprag retainer for an overrunning clutch that will minimize and/or eliminate one or more of the above-identified deficiencies.

### SUMMARY OF THE INVENTION

The present invention provides a sprag retainer for an overrunning clutch.

A sprag retainer in accordance with one embodiment of the present invention includes first and second rings disposed about an axis and axially spaced from one another. The retainer further includes a plurality of cross bars extending between the first and second rings. The plurality of cross bars are circumferentially spaced and define a plurality of openings with each opening configured to receive one of the plurality of sprags. At least the plurality of cross bars are formed from a tool steel. The tool steel may comprise a shock resisting tool steel and, in particular, may comprise AISI (American Iron and Steel Institute) S7 tool steel.

A sprag retainer in accordance with the present invention represents an improvement over retainers found in conventional overrunning clutches. In particular, the inventive retainer has significantly improved abrasion resistance during engagement of the cross bars of the retainer with the sprags. Because the cross bars are more resistant to wear, the sprags also suffer less wear and damage are less subject to misalignment. As a result, the service life of the clutch is extended and damage to the clutch and/or drive system is less likely to occur. Moreover, systems employing the clutch require fewer inspections and less maintenance, resulting in increased operating time for the system and reduced costs.

These and other advantages of this invention will become apparent to one skilled in the art from the following detailed description and the accompanying drawings illustrating features of this invention by way of example.

### BRIEF DESCRIPTION OF THE DRAWINGS

FIG. 1 is side view of an overrunning clutch in accordance with the present invention.

FIG. 2 is a cross-sectional view of the overrunning clutch of FIG. 1 taken along lines 2-2.

FIG. 3 is an enlarged sectional view of a portion of the overrunning clutch of FIG. 2 taken along lines 3-3.

FIG. 4 is a perspective view of a sprag retainer for an overrunning clutch in accordance with one embodiment of the present invention.

### DETAILED DESCRIPTION OF EMBODIMENTS OF THE INVENTION

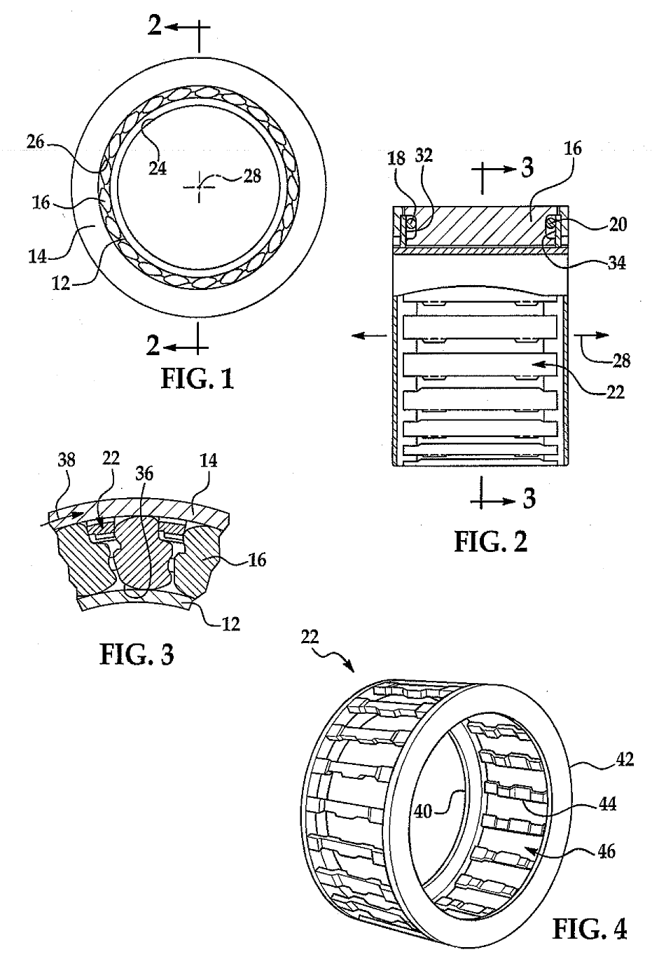

Referring now to the drawings wherein like reference numerals are used to identify identical components in the various views, FIGS. 1-2 illustrates an overrunning clutch 10 in accordance with the present invention. Clutch 10 is provided to transmit torque between two rotational bodies. Clutch 10 may include inner and outer race members 12, 14, a plurality of sprags 16, springs 18, 20 and a sprag retainer 22.

Inner and outer race members 12, 14 may be coupled to driving and driven bodies (not shown), respectively and are provided to enable transmission of torque between the driving and driven bodies. Inner and outer race member 12, 14 also define inner and outer raceways 24, 26, respectively for a purpose described hereinbelow. Inner and outer race members 12, 14 are conventional in the art and may be made from conventional metals and metal alloys. Inner and outer race members 12, 14 are annular in shape and are disposed about a common rotational axis. 28. Outer race member 14 is disposed radially outward of inner race member 12 and is radially spaced from inner race member 12. Race members 12, 14 may be coupled to the driving and driven bodies in any number of conventional ways including by keys, splines or an interference fit. For exemplary purposes, inner race member 12 will be described herein as coupled to the driving body and outer race member 14 will be described as coupled to the driven body. It should be understood, however, that this arrangement could be reversed with race member 12 coupled to the driven body and race member 14 coupled to the driving body.

Sprags 16 are provided to transmit torque between race members 12, 14 and to allow race member 14 to freewheel or to overrun race member 12 under certain circumstances. Sprags 16 are conventional in the art and may be made from heat treated steel (e.g., SAE 52100 steel). Sprags 16 are disposed radially between race members 12, 14 and raceways 24, 26. Each of sprags 16 has a shape and profile designed to accomplish several functions. Referring to FIG. 2, each sprag 16 has recesses 32, 34 formed at either axial end configured to receive springs 18, 20. Referring to FIG. 3, each sprag 16 has a profile 36 in axial cross-section that causes the sprag to engage and wedge between inner and outer race member 12, 14 when inner race member is rotating in a first rotational direction (the driving direction) illustrated by the arrow 38. The same profile 36 causes the sprag 16 to disengage from contact with the outer race member 14 if the outer race member 14 begins rotating in the opposite rotational direction (e.g., due to a load placed on the driven member) or if the outer race member 14 begins to rotate faster than the inner race member 12 in the driving direction. This action allows the outer race member 14 to freewheel or overrun the inner race member 12. The shape and profile of sprags 16 also enable sprags 16 to be positioned within and relative to retainer 22. In one embodiment of the invention, sprags 16 may have the shape and profile set forth in U.S. Pat. No. 3,302,761, the entire disclosure of which is incorporated herein by reference.

Springs 18, 20 are provided to bias sprags 16 to a predetermined position. Springs 18, 20 are conventional in the art and may be made from music wire (ASTM A228). Springs 18, 20 may be annular coil springs and are disposed within recesses 32, 24 of sprags 16. Springs 18, 20 bias sprags 16 radially outwardly towards raceway 26 of outer race 14.

Retainer 22 is provided to maintain the relative positioning of sprags 16. Retainer 22 is disposed radially between inner and outer race members 12, 14. Referring to FIG. 4, retainer 22 includes annular rings 40, 42 axially spaced from one another and located at either axial end of retainer 22. Retainer 22 further includes a plurality of cross bars 44 extending axially between rings 40, 42. Cross bars 44 are circumferentially spaced and defining openings 46 therebetween configured to receive sprags 16. Cross bars 44 may be integral with rings 40, 42 to form a unitary structure or may be separately coupled to rings 40, 42 by welds for example.

In accordance with the present invention, at least cross bars 44 (but possibly rings 40, 42 as well) are made from a tool steel. The inventor herein has determined that the cross bars of conventional sprag retainers exhibit insufficient wear resistance resulting from contact with sprags 16. As the cross bars wear, sprags 16 are susceptible to misalignment within the clutch thereby decreasing the service live of the clutch and creating the potential for damage to the clutch and/or drive system in which the clutch is employed. The inventor herein has determined that manufacturing the cross bars 44 from a tool steel will significantly increase the wear or abrasion resistance of the retainer 22 and increase the service life of the clutch 10. The tool steel may comprise a shock resisting tool steel (i.e. one of the tool steels having an “S” designation under AISI standards). In particular, the tool steel may comprise AISI S7 tool steel. The tool steel preferably includes, by weight, between 0.45% and 0.55% carbon, between 3.0% and 3.5% chromium and between 1.3% and 1.8% molybdenum. The tool steel may also include, by weight, between 0.2% and 0.9% manganese and between 0.2% and 1% silicon and may further include, by weight, between 0.2% and 0.3% vanadium.

A sprag retainer 22 in accordance with the present invention represents a significant improvement as compared to conventional sprag retainers. The inventive retainer 22 has significantly improved abrasion resistance within the cross bars 44 that retain and position the sprags 16. As a result, sprags 16 are not as susceptible to misalignment. This improves the service life of the clutch 10 and protects the clutch 10 and drive system from damage. Further, systems employing the clutch require fewer inspections and less maintenance, resulting in increased operating time for the system and reduced costs.

While the invention has been shown and described with reference to one or more particular embodiments thereof, it will be understood by those of skill in the art that various changes and modifications can be made without departing from the spirit and scope of the invention.

I claim:

1. An overrunning clutch, comprising:
an inner race member configured for rotation about a rotational axis;
an outer race member configured for rotation about said rotational axis and spaced radially outwardly of said inner race member;
a plurality of sprags disposed between said inner and outer race members;
a retainer disposed between said inner and outer race members, said retainer including:
first and second rings axially spaced from one another;
a plurality of cross bars extending between said first and second rings, said plurality of cross bars circumferentially spaced and defining a plurality of openings, each opening of said plurality of openings configured to receive one of said plurality of sprags
wherein at least said plurality of cross bars are formed from a tool steel.

2. The overrunning clutch of claim 1, further comprising a spring biasing said plurality of sprags into a position of engagement with said inner and outer race members.

3. The overrunning clutch of claim 1 wherein said tool steel comprises a shock resisting tool steel.

4. The overrunning clutch of claim 1 wherein said tool steel comprises AISI S7 tool steel.

5. The overrunning clutch of claim 1 wherein said tool steel includes, by weight, between 0.45% and 0.55% carbon, between 3.0% and 3.5% chromium and between 1.3% and 1.8% molybdenum.

6. The overrunning clutch of claim 5 wherein said tool steel further includes, by weight, between 0.2% and 0.9% manganese and between 0.2% and 1% silicon.

7. The overrunning clutch of claim 6 wherein said tool steel further includes, by weight, between 0.2% and 0.3% vanadium.

8. A retainer for a plurality of sprags in an overrunning clutch, said retainer including:
first and second rings disposed about an axis and axially spaced from one another;
a plurality of cross bars extending between said first and second rings, said plurality of cross bars circumferentially spaced and defining a plurality of openings, each opening of said plurality of openings configured to receive one of said plurality of sprags
wherein at least said plurality of cross bars are formed from a tool steel.

9. The retainer of claim 8 wherein said tool steel comprises a shock resisting tool steel.

10. The retainer of claim 8 wherein said tool steel comprises AISI S7 tool steel.

11. The retainer of claim 8 wherein said tool steel includes, by weight, between 0.45% and 0.55% carbon, between 3.0% and 3.5% chromium and between 1.3% and 1.8% molybdenum.

12. The retainer of claim 11 wherein said tool steel further includes, by weight, between 0.2% and 0.9% manganese and between 0.2% and 1% silicon.

13. The retainer of claim 12 wherein said tool steel further includes, by weight, between 0.2% and 0.3% vanadium.
